(19) United States
(12) Patent Application Publication
(10) Pub. No.: US 2009/0114883 A1
(43) Pub. Date: May 7, 2009

(54) Metal-filled nanostructures

(75) Inventors: Charles Patrick Collier, San Marino, CA (US); Konstantinos P. Giapis, Pasadena, CA (US); Jinyu Chen, Los Angeles, CA (US); Oleksandr Kutana, Pasadena, CA (US)

Correspondence Address: UNIDYM, 201 SOUTH LAKE AVE., SUITE 703, PASADENA, CA, 91101, US

(73) Assignee: California Institute of Technology, Pasadena, CA (US)

(21) Appl. No.: 11/545,861

(22) Filed: Oct. 11, 2006

Related U.S. Application Data
(60) Provisional application No. 60/726,039, filed on Oct. 12, 2005.

(51) Int. Cl. H01B 1/04; H01B 1/02

(52) U.S. Cl. 252/503; 252/512; 977/750; 977/762

(57) ABSTRACT

A metal-filled nanostructure and fabrication methods thereof are discussed. A metal-filled nanostructure according to an embodiment of the present invention comprises a metal filling and a nanostructure shell, and may provide superior conductivity and contact resistance over those inherent in the nanostructure shell. In a preferred embodiment, the metal filled nanostructure comprises a continuous metal nanowire inserted into a single-walled carbon nanotube using an electrowetting technique.

This application claims priority to U.S. Provisional Patent Application No. 60/726,039, filed Oct. 12, 2005, and entitled “ELECTROWETTING IN CARBON NANOTUBES,” which is hereby incorporated herein by reference.

### COPYRIGHT & TRADEMARK NOTICE

A portion of the disclosure of this patent document contains material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or limit the scope of this invention to material associated only with such marks.

1. Field of the Invention

The present invention relates in general to nanostructures, and specifically to metal-filled nanostructures.

2. Background

Nanostructures (e.g., nanotubes, nanowires) have attracted a great deal of recent attention, because of their remarkable material characteristics.

Single-walled carbon nanotubes (SWNTs) in particular have exhibited exceptional mechanical, thermal and electrical properties. These generally-hollow nanostructures can be conceptualized by wrapping a one-atom-thick layer of graphene into a seamless cylinder, with a diameter typically on the order of a few nanometers and a length that can be many thousands of times larger (e.g., centimeters). Given this structure, in theory nanotubes can have an electrical current density more than 1,000 times greater than metals such as silver and copper.

However, although nanotubes display extremely high electrical conductivities, electrical contacts to nanotubes typically exhibit high resistance, posing a serious obstacle to their application in electronic devices. Additionally, the electrical properties of a nanotube depend largely on how the graphene layer thereof is wrapped, with most current fabrication methods yielding a jumble of semiconducting and metallic nanotubes (e.g., 75% semiconducting, 25% metallic), and providing no way to separate the two types on a large-scale.

Nanowires have also exhibited extraordinary material properties, and can be, for example, metallic (e.g., Ni, Pt, Au), semiconducting (e.g., InP, Si, GaN, etc.), and/or insulating (e.g., SiO₂,TiO₂). These nanostructures typically have a lateral dimension constrained to less than tens of nanometers and an unconstrained longitudinal size. At these scales, quantum mechanical effects result in such nanostructures having many interesting properties that are not seen in bulk or 3-D materials (e.g., quantum conductance).

Unfortunately, although there are a variety of top-down (e.g., etching a larger wire) and bottom-up (e.g., thermal evaporation, chemical vapor deposition, vapor-solid process, laser assisted catalytic growth) nanowire fabrication techniques, it is currently very difficult to produce a high-yield of nanowires and/or to produce nanowires having uniform lengths. Moreover, once fabricated, nanowires are often difficult to implement into electronic device architectures (e.g., catalytic particles typically remain attached to the nanowires even after the completion of the nanowire fabrication process). Hence, new nanostructures and/or improvements on currently-known nanostructures will be required for next generation electronic devices.

### SUMMARY OF THE INVENTION

The present invention provides a novel nanostructure and fabrication methods thereof. Specifically, the present invention comprises a metal-filled nanostructure.

In one embodiment of the present invention, the nanostructure comprises a metal filling inserted into a nanostructure shell. This metal filling may increase electrical conductivity and/or contact resistance beyond the inherent electrical properties of the nanostructure shell (i.e. without a metal filling).

The nanostructure shell is preferably open, and may be selected and/or fabricated as such (e.g., etched). The nanostructure shell may moreover be a single-walled carbon nanotube (SWNT), the hollow core of which makes it ideal for metal filling.

The metal filling is preferably continuous, and may form a continuous metal nanowire within the nanostructure shell. This metal filling may, for example, be trapped inside the nanostructure shell (e.g., by closing opening(s) in the nanostructure shell and/or freezing the metal), or be inserted and released by controlled electrowetting (e.g., where the nanostructure shell is used as a nano-pipette).

A method of fabricating the above-described embodiments comprises inserting a metal filling into a nanostructure shell using, for example, electrowetting. The nanostructure shell is preferably open to facilitate insertion of the metal filling, and may be selected or fabricated (e.g., etched) to have that property.

Once the metal filling is inserted into the nanostructure shell, it may be trapped inside (e.g., by closing the opening(s) in the nanostructure shell and/or freezing the metal). The nanostructure shell may additionally or alternatively be dissolved to expose the metal filling formed therein (e.g., as a nanowire fabrication technique).

The fabrication methods described herein are scalable, and may be used to insert metal fillings into multiple nanostructure shells within the same electrowetting process (e.g., filling an array of vertically-aligned SWNTs in parallel).

Applications of a metal-filled nanostructure according to the present invention include, but are not limited to, interconnects (e.g., metal-filled SWNTs having improved contact resistance over hollow SWNTs), catalytic nanowires (e.g., formed by dissolving the nanostructure shell after metal filling), nanotube sorting (e.g., converting mixed semiconducting and metallic nanotubes into metallic nanostructures), atomic force microscope (AFM) tips (e.g., magnetic, ultra-sensitive), and nano-pipettes.

Other features and advantages of the invention will be apparent from the accompanying drawings and from the detailed description. One or more of the above-disclosed embodiments, in addition to certain alternatives, are provided in further detail below with reference to the attached figures. The invention is not limited to any particular embodiment disclosed.

### BRIEF DESCRIPTION OF THE DRAWINGS

The accompanying drawings are included to provide a further understanding of the invention, and are incorporated in and constitute a part of this specification. Each drawing illustrates one or more embodiments of the invention, and together with the description serves to explain the principles of the invention.

FIG. 1 is a schematic simulation of metal molecules filling a single wall nanotube (SWNT), according to an embodiment of the present invention.

FIG. 2 is a schematic representation of an interconnect according to an embodiment of the present invention.

FIG. 3 is a flowchart describing a method of fabricating metal-filled nanostructures according to an embodiment of the present invention.

FIG. 4 is a schematic representation of a large-scale metal-filled nanostructure fabrication method and apparatus.

FIG. 5 graphs current-voltage (I-V) curves for metal-filled nanostructures at different points during a metal-filling process, and demonstrates the increased conductivity associated with such nanostructures.

FIG. 6A graphs pull-off force as a function of applied tip voltage for a 120-nm-long carbon nanotube. The force is measured by extracting the nanotube from the mercury surface at the corresponding voltage. Error bars show means ± standard deviation.

FIG. 6B is a histogram of pull-off forces measured by using 14 different nanotube probes. The “before activation” region corresponds to 188 force-distance curves for six nanotubes recorded at a tip bias of 0 V. The “after activation” region corresponds to 176 force-distance curves from eight nanotubes recorded at a tip bias of ±2 V.

FIG. 7 is a transmission electron micrograph (TEM) image of a segment of an activated SWNT, the upper core of which is filled with a metallic material.

FIG. 8A is a TEM image of an activated 180-nm-long SWNT attached to a gold-coated AFM tip.

FIG. 8B is a TEM image showing a zoomed-out view of the SWNT and AFM tip of FIG. 8A.

FIG. 8C is a TEM image of a different gold-coated AFM tip without a nanotube, which has been deliberately dipped into mercury to expose the Si tip apex by gold dissolution.

Features, elements, and aspects of the invention that are referenced by the same numerals in different figures represent the same, equivalent, or similar features, elements, or aspects in accordance with one or more embodiments of the system.

### DETAILED DESCRIPTION OF THE PREFERRED EMBODIMENTS

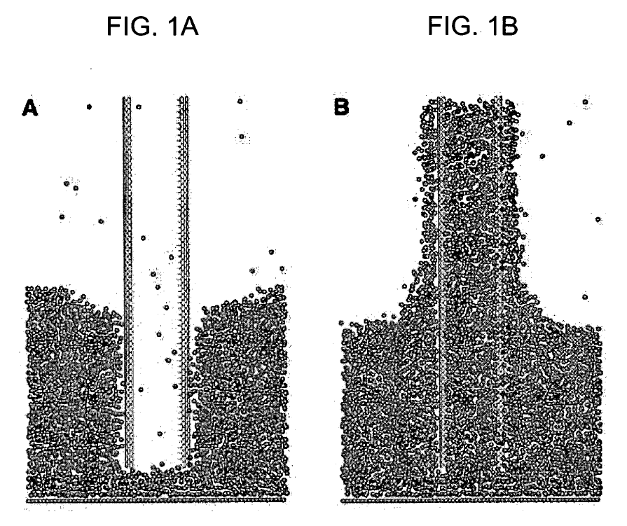

Referring to FIG. 1, in accordance with an embodiment of the present invention, a metal-filled nanostructure is provided.

In a preferred embodiment, the nanostructure comprises a single-walled carbon nanotube (SWNT) and a continuous metal nanowire therein. This hybrid nanostructure is capable of higher electrical conductivity than the intrinsic conductivity of a nanotube. For example, in a 270 nm long SWNT, an activated (i.e. metal-filled) probe resistance of 3.79±0.18 kΩ was measured—equivalent to roughly four times the conductance quantum G₀=(12.9 kΩ)⁻¹. In addition, metal-filled nanostructures according to embodiments of the present invention have displayed much lower contact resistances than nanotubes.

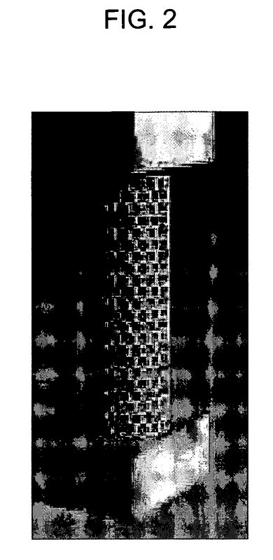

Referring to FIG. 2, these electrical properties make such nanostructures ideal candidates for next-generation interconnects.

As consumer demand grows for smaller and faster computer chips, conventional copper interconnects become more and more difficult and costly to fabricate. Further, copper's structural and electrical properties intrinsically degrade at smaller scales, due largely to electromigration and thermomigration. Nanotubes do not share these problems (copper burns out at 1 million amps per square centimeter while SWNTs can carry up to a billion amps per square centimeter due to, for example, ballistic transport in metallic SWNTs), but generally display high contact resistances at metal/nanotube interfaces

In contrast, metal-filled nanostructures according to embodiments of the present invention can have both high conductivity and relatively low contact resistance at a metal interface. Their high conductivity may result from electron transmission through the metal-filled core and/or shorting of semiconducting portions of the nanostructure (e.g., SWNT) shell. Their low contact resistance is hardly surprising given that both conventional interconnects and the continuous nanowire formed in a preferred embodiment of the present invention are metallic (e.g., comprising copper). In fact, such continuous nanowires can themselves be used as interconnects without nanostructure shells (e.g., where the nanostructure shells are dissolved once the nanowires are formed therein).

These barren nanowires may find further use as catalysts in, for example, fuel cells, where current is generated by stripping hydrogen atoms from a chemical source, breaking them apart on a catalyst (e.g., platinum), and harvesting the electrons. In such fuel cells, the more fuel that can be brought into contact with the catalyst, the more current can be drawn from the cell. Thus, a high catalytic surface area, such as that of a platinum nanowire, is key to efficiency.

In addition to improving the conductivity of metallic nanotubes, the metal-filled core of the present invention may dramatically increase the conductance of initially semiconducting nanotubes upon probe activation. In essence, adding a metal filling can convert a semiconducting nanotube into a metallic nanostructure by, for example, shorting the semiconducting portions of a nanotube and/or providing metallic electron transport through the metal-filled core. This ability may solve one of the biggest hurdles facing nanotube commercialization-the fact that most current fabrication methods yield a jumble of semiconducting and metallic nanotubes (e.g., 75% semiconducting, 25% metallic). By filling such nanotubes with an appropriate metal, one can produce a batch of all metallic nanostructures.

Additionally, the metal-fillings of the present invention may do more than simply give nanostructures metallic properties. Virtually any metal and/or composite thereof can be inserted into a nanostructure using the methods claimed herein, so long as the melting-temperature of the metal is less than the dissolution temperature of the nanostructure shell being filled. In the case of nanotubes, which are generally very thermally robust, the range of potential metal fillings is very broad. For example, a magnetic metal filling (e.g., lead) may be driven into a SWNT for use as a magnetic atomic force microscope (AFM) tip.

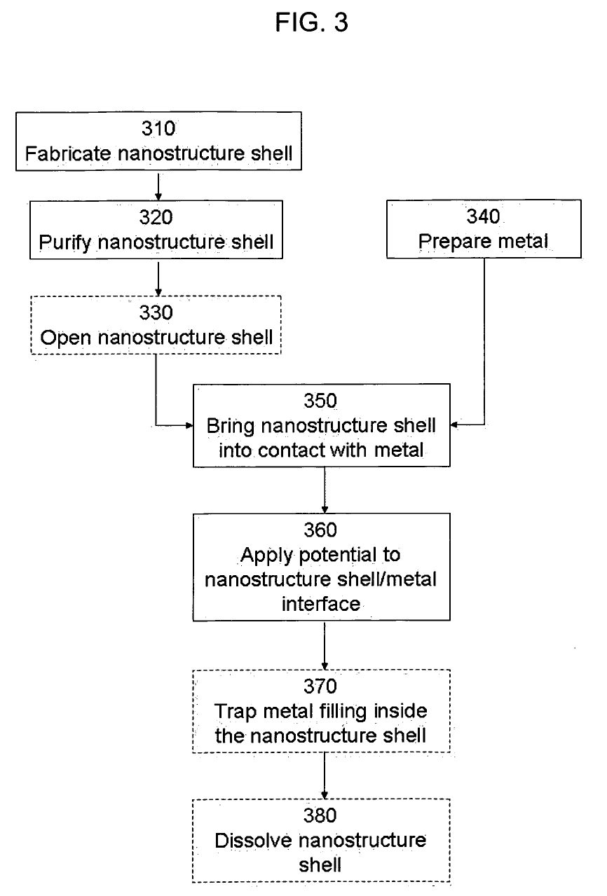

Referring to FIG. 3, a method for fabricating the above-described metal-filled nanostructures according to an embodiment of the present invention employs an electrowetting (aka, electrocapillarity) technique.

Electrowetting is a phenomenon whereby an electric field modifies the wetting behavior of a droplet in contact with an electrode. The effect is based on electrostatic control of the solid-fluid interfacial tension, and is an activated process with a threshold voltage.

For example, an electrowetting process may comprise bringing a nanostructure shell into contact with a liquid-phase metal 350 and applying a potential to the nanostructure/metal interface 360, causing a charge to build up across the nanostructure/metal contact. The repulsion between similar electric charges present at the metal surface lowers the surface tension, and at a critical applied potential, wetting may commence that forces liquid metal up into the nanostructure. Wetting may also cause metal to coat the nanostructure exterior.

In a preferred embodiment, the nanostructure shells are SWNTs (given that their hollow inner cores are well-suited for metal filling), and the method according to an embodiment of the present invention further comprises fabricating 310 and purifying 320 these nanostructures. The nanostructure shells are preferably open-ended, and may need to be selected as such or selectively etched 330. Additionally, the metal filling is preferably inserted in liquid phase, and thus may also require preparation 340 (e.g., purification and melting).

In a further embodiment of the present invention, the metal may be trapped inside the nanostructure shell 370 by, for example, sealing the ends of the nanostructure shell and/or freezing it inside the nanostructure shell by reducing the ambient temperature to below the melting temperature of the metal.

Alternatively, the nanostructure shell (e.g., SWNT) may be used as, for example, a nano-pipette, wherein metal is driven into the nanotube by electrowetting, and subsequently released, e.g., at a desired location and/or rate by removing the applied electrowetting potential. Thus, the present invention also has important implications for nanofluidics.

In yet a further embodiment of the present invention, the nanostructure shell may be dissolved 380 to expose the metal filling. This step may be desirable in a preferred embodiment, where the metal filling comprises a continuous metal nanowire. The resulting barren nanowire may find, for example, catalytic applications as described above.

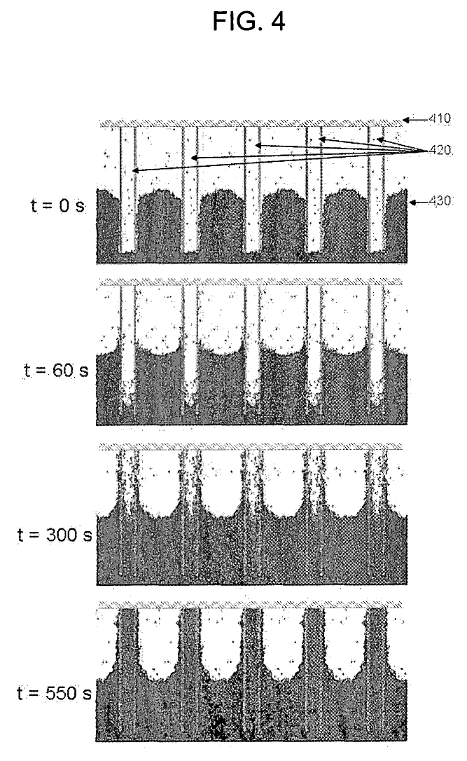

Referring to FIG. 4, in still a further embodiment of the present invention, a large-scale metal-filled nanostructure fabrication method may employ an array of vertically aligned nanotubes 420 (e.g., grown by chemical vapor deposition on a substrate 410). The nanotubes of the array are preferably open-ended and about the same length, such that their ends may be submerged to about the same depth in a liquid metal 430 (e.g., at t=0 s). Once the ends are submerged, a potential may be applied to the nanotube/metal interface, and the nanotubes may thereby be filled in parallel (e.g., at t=60, 300 and 550 s).

It should be noted that although the above-described embodiments refer to nanotubes, the present invention may be applicable to other nanostructures including, but not limited to, nanowires, nanoparticles, nanopores and graphene flakes. The present invention may also be broadly applied to a wide range of nanotubes (e.g., single-walled, multi-walled, carbon, silicon, boron nitride, short, long, etc.). Likewise, the present invention may be applied to virtually any metal with a melting temperature less than the dissolution temperature of the nanostructure shell into which the metal is to be inserted.

In an exemplary experiment, nanotubes (e.g., grown by chemical vapor deposition on a silicon wafer decorated with iron nanoparticles) were attached to atomic force microscope (AFM) tips (e.g., composed of gold-coated silicon) to form nanotube probes (e.g., using the pickup technique of Hafner et al., J. Phys. Chem. B 105, 743 (2001)). Attached SWNTs with suspended lengths of between 200-600 nm were selected for further processing. Such SWNTs had an average diameter of 5±1 nm and were defect-free as inferred from transmission electron microscopy (TEM) images.

After annealing (e.g., for 36 hours at 180° C.), each nanotube probe was subjected to electric pulse etching (e.g., 1.5-3.5 V, 20 μs) against a fresh highly-oriented pyrolytic graphite (HOPG) surface. This etching shortened each nanotube (e.g., to 50-200 nm) to reduce bending and buckling effects, and opened up its suspended free end to facilitate access to its inner core.

At ambient conditions, the shortened nanotube probe was then brought into contact with a fresh droplet of liquid mercury (e.g., diameter˜200 μm) by engaging the probe in tapping mode on the droplet surface (e.g., using a Digital Instruments AFM with Nanoscope IV controller, which allowed precise and controllable positioning of the probe so that both the total length of the SWNT and the length immersed in the droplet could be determined). Precautions were taken to prevent the AFM tip from contacting the mercury surface directly, as mercury can dissolve gold and cause SWNT loss.

With the SWNT immersed into mercury by 17±2 nm, electrical direct-current potentials were applied to the nanotube probe while tip conductance was monitored (e.g., with mercury at ground).

Resistances were measured at low bias (100 mV), and two types of experiments were performed. For a fixed probe position, current-voltage (I-V) curves were recorded; and alternatively, the SWNT was lifted from the droplet surface at fixed applied potential in order to measure the (pull-off) force acting on the tip.

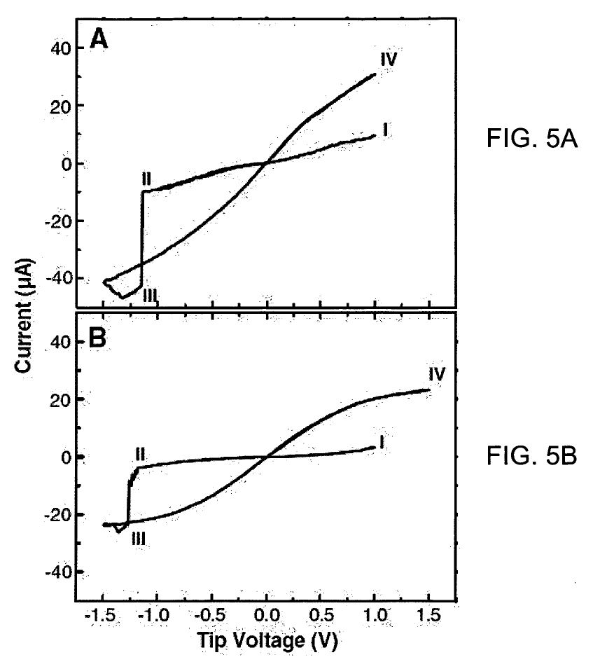

Referring to FIG. 5, recorded I-V curves evidenced metal-filling of nanotube probes during exemplary experiments. FIGS. 5A and 5B correspond to an 80-nm-long metallic SWNT and a 130-nm-long semiconducting SWNT, respectively, immersed by about 17±2 nm into a mercury droplet. In both graphs, curve I to II corresponds to a low-conductivity state; and curve II to III indicates the abrupt transition to a higher conductivity state (e.g., at a threshold electrowetting voltage), which is in turn described by curve III to IV.

Typical I-V curves for shortened nanotube probes show initially (I→II) low currents (2-10 μA) measured for potentials between −1 to +1 V. The probe of FIG. 5A has a low bias resistance of 208±20 kΩ, consistent with the range of values reported for good contact between metallic SWNTs and gold-coated AFM tips. The probe of FIG. 5B has a resistance of 1.65±0.29 MΩ and a slightly asymmetric I-V curve (I→II), both indicative of a semiconducting SWNT. Probe resistances from a large number of metallic SWNTs were found to be between 100-300 kΩ, with no apparent correlation with the length of the truncated SWNT. Semiconducting SWNTs had significantly higher resistances (1-3 MΩ). The I-V curves were stable with voltage cycling between ±1 V.

Increasing the voltage to a threshold value between ±1 and ±2 V while keeping nanotubes immersed in the mercury at fixed depth resulted in an abrupt and large increase in conductivity (curve II→III), for both metallic and semiconducting SWNTs. The jump to high current (termed “probe activation”) occurred at −1.15 V for the metallic SWNT probe (see FIG. 5A). Further increase in the applied voltage to −1.50 V caused a slight variation in current. Subsequent cycling of the voltage between ±1.5 V results in stable I-V curves at elevated currents (curves III→IV) for several cycles. The low bias resistance of the metallic nanotube probe in its activated state decreased to 29±4 kΩ.

The semiconducting nanotube probe exhibited similar behavior (see FIG. 5B). Probe activation occurred at −1.26 V and its resistance dropped to 46.8±2.9 kΩ, remarkably close to that of the activated metallic nanotube (see FIG. 5A).

In addition to negative potentials, probe activation also occurred consistently at similar (absolute) positive potentials. For negative voltage sweeps, average activation thresholds were −1.5±0.5 V for metallic and −1.3±0.3 V for semiconducting nanotubes. After activation, and as long as the SWNT tip remained immersed, the high conductivity behavior is maintained upon voltage cycling through zero bias, although a drift to higher resistances was seen at long times (>5 min). When the SWNTs were completely removed from the mercury surface, they reverted to a low conductivity state, although the corresponding resistance was generally lower than that before the first activation. The probe can be re-activated at a lower voltage than the initial threshold established previously, and the high conductivity state is then fully recovered.

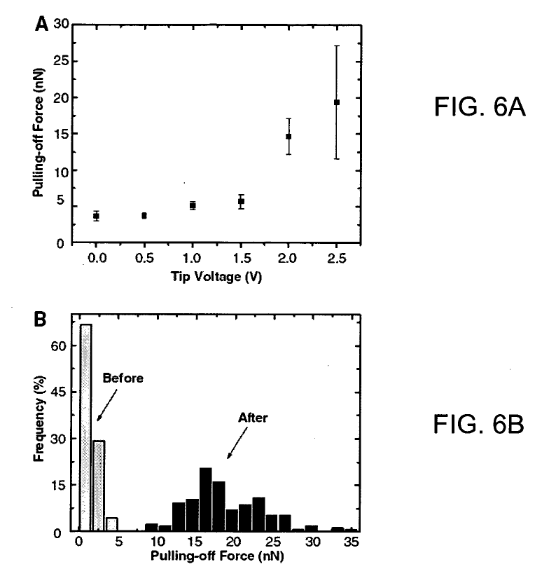

Referring to FIG. 6, simultaneous measurement of the tip pull-off force from numerous force-distance curves with tip voltage indicated that probe activation coincides with a roughly fivefold increase in the attraction between the nanotube probes and mercury (see FIG. 6A). This trend was consistent and readily observable for both metallic and semiconducting nanotubes (see FIG. 6B). Relatively weak pull-off forces between 1-5 nN are measured before activation as compared to strong forces of 11-30 nN after activation.

The above-observed behavior was attributable to electrically activated wetting and filling of SWNTs by mercury.

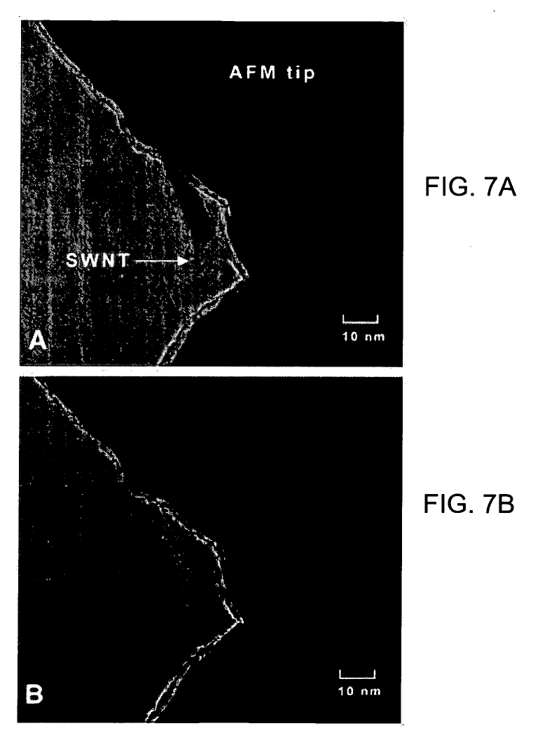

Referring to FIG. 7, additional evidence of electrically activated wetting and filling of nanotubes by mercury comprises ex-situ transmission electron micrograph (TEM) images of mercury penetrating and filling a nanotube's inner core. FIG. 7A shows a segment of a 150 nm long SWNT along the sidewall of an AFM tip. The darker material visible inside the nanotube formed a highly curved meniscus with a contact angle of 150±5°, which is remarkably close to that of mercury on graphite. Focusing the TEM electron beam on this material caused it to vanish (e.g., move or evaporate rapidly), further indicating that this material was mercury (e.g., in its liquid, non-wetting state) (see FIG. 7B).

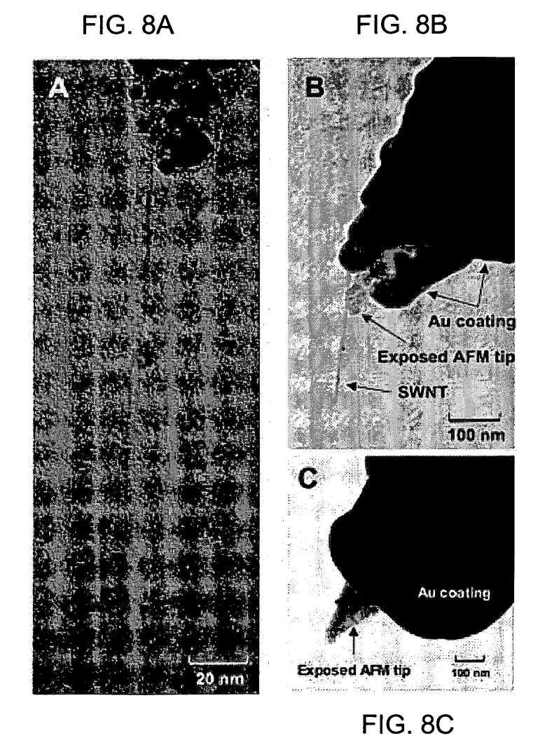

Referring to FIG. 8, additional evidence of material inside an activated nanotube comprises a TEM image of an activated 180 nm long SWNT attached to a gold-coated AFM tip. FIG. 8A shows a discernable darker material in the center of the lower half of a SWNT. Readily apparent in FIG. 8B is the dissolution of the gold-coating at the AFM tip apex, which exposes the silicon tip. Although this tip did not touch the mercury surface, its appearance is identical to that of a coated tip without a nanotube (see FIG. 8C) that was briefly immersed into mercury deliberately. Therefore, the mercury must have been transported to the tip by another mechanism, e.g., evaporation, thermomigration, electromigration, and/or electrowetting. Of these four possibilities, electrowetting is the most likely mechanism.

In other exemplary experiments, nanostructures were filled with metals that are solid at room temperatures (e.g., gallium, gallium eutectic) using methods according to the present invention as disclosed above.

The present invention has been described above with reference to preferred features and embodiments. Those skilled in the art will recognize, however, that changes and modifications may be made in these preferred embodiments without departing from the scope of the present invention. These and various other adaptations and combinations of the embodiments disclosed are within the scope of the invention.

What is claimed is:

1. A nanostructure, comprising:
a metal filling; and
a nanostructure shell, wherein the metal filling is inserted in the nanostructure shell.

2. The nanostructure of claim 1, wherein the metal filling increases an electrical conductivity of the nanostructure to above an inherent electrical conductivity of the nanostructure shell.

3. The nanostructure of claim 2, wherein the nanostructure shell is open.

4. The nanostructure of claim 3, wherein the nanostructure shell is a nanotube.

5. The nanostructure of claim 4, wherein the metal filling comprises a continuous metal nanowire in an inner core of the nanostructure shell.

6. The nanostructure of claim 5, wherein the nanostructure shell is a single-walled carbon nanotube (SWNT).

7. The nanostructure of claim 6, wherein the metal filling decreases a contact resistance of the nanostructure to below an inherent contact resistance of the nanostructure shell.

8. The nanostructure of claim 7, wherein the nanostructure is attached to an atomic force microscope.

9. An interconnect, comprising a metal-filled nanostructure.

10. The nanostructure of claim 9, wherein the metal-filled nanostructure comprises a continuous metal nanowire within a single-walled carbon nanotube.

11. A method of fabricating a metal-filled nanostructure, comprising inserting a metal filling into a nanostructure shell.

12. The method of claim 11, wherein the metal filling is continuous.

13. The method of claim 12, further comprising bringing the nanostructure shell into contact with a liquid metal prior to inserting the metal filling.

14. The method of claim 13, wherein the metal filling is inserted into the nanostructure by electrowetting.

15. The method of claim 14, wherein the nanostructure shell is a single-walled carbon nanotube (SWNT).

16. The method of claim 15, wherein the metal filling forms a nanowire in a hollow core of the nanostructure shell.

17. The method of claim 16, further comprising opening the nanostructure shell prior to bringing the nanostructure shell into contact with the liquid metal.

18. The method of claim 17, further comprising trapping the metal filling inside the nanostructure shell.

19. The method of claim 18, further comprising dissolving the nanostructure shell after inserting the metal filling, wherein the metal filling remains intact even after the nanostructure shell has dissolved.

20. The method of claim 15, wherein at least a second metal-filled nanostructure is fabricated in parallel with the metal-filled nanostructure,
wherein the second metal-filled nanostructure comprises a second nanostructure shell,
wherein the nanostructure shell and the second nanostructure shell are vertically aligned, and
wherein the nanostructure shell and the second nanostructure shell are together brought into contact with the liquid metal.
